(19) United States
(12) Patent Application Publication
(10) Pub. No.: US 2015/0370995 A1
(43) Pub. Date: Dec. 24, 2015

(54) MEDICAL FLUID ANALYSIS APPARATUS AND MEDICAL FLUID ANALYSIS METHOD

(71) Applicants: KABUSHIKI KAISHA TOSHIBA, Minato-ku (JP); TOSHIBA MEDICAL SYSTEMS CORPORATION, Otawara-shi (JP)

(72) Inventor: Satoshi WAKAI, Nasushiobara (JP)

(73) Assignees: KABUSHIKI KAISHA TOSHIBA, Minato-ku (JP); TOSHIBA MEDICAL SYSTEMS CORPORATION, Otawara-shi (JP)

(21) Appl. No.: 14/839,248

(22) Filed: Aug. 28, 2015

Related U.S. Application Data
(63) Continuation of application No. PCT/JP2014/059105, filed on Mar. 28, 2014.

(30) Foreign Application Priority Data
Mar. 28, 2013 (JP) 2013-069134

(51) Int. Cl. G06F 19/00; G06F 17/16

(52) U.S. Cl. CPC G06F 19/3437; G06F 17/16

(57) ABSTRACT

According to embodiment, a medical fluid analysis apparatus includes processing circuitry generating a treatment model in which a device model is placed in a body cavity model, the device model representing a shape of a treatment device to be placed inside a body cavity of a subject, the body cavity model representing a shape of the cavity, performing a fluid analysis on a fluid in the treatment model with a modification of the treatment model, based on characteristics at least including hardness of body cavity tissue in the body cavity model, characteristics at least including hardness of the treatment device in the device model, and fluid characteristics of the fluid inside the body cavity in the body cavity model, and outputting an analysis result obtained by the processing circuitry.

### CROSS-REFERENCE TO RELATED APPLICATIONS

This application is a Continuation Application of PCT Application No. PCT/JP2014/059105, filed Mar. 28, 2014 and based upon and claims the benefit of priority from the Japanese Patent Application No. 2013-069134, filed Mar. 28, 2013, the entire contents of all of which are incorporated herein by reference.

### FIELD

The embodiments relate to a medical fluid analysis apparatus and a medical fluid analysis method.

### BACKGROUND

As a therapeutic method of arranging a treatment device inside a blood vessel of a subject, a transcatheter aortic valve replacement (TAVR), a stent indwelling technique, and a coil embolization technique, etc. are known. TAVR is sometimes called “transcatheter aortic valve implantation (TAVI)”.

TAVR is a therapeutic method for replacing an aortic valve with an artificial valve by inserting a catheter, to which an artificial valve is attached at the tip, into a blood vessel of a subject, and carrying the tip of the catheter to the location of the aortic valve.

With the stent indwelling technique, a catheter to which a stent which is, for example, a tube of a metal fabric or a stent graft with an artificial vessel attached at the tip, is inserted into a blood vessel of a subject to carry the tip of the catheter to, for example, a stenosed part in a coronary artery, and the stent or the stent graph expands and indwells at the stenosed part.

With the coil embolization technique, a catheter is inserted into a blood vessel of a subject, and the tip of the catheter is carried to a cerebral aneurysm in the subject's head, and an ultrathin platinum coil embolizes inside the cerebral aneurysm through the catheter to avoid blood flowing into the cerebral aneurysm.

To carry out these therapeutic methods, it is necessary to place a treatment device so as to optimize a blood flow inside the blood vessel after placing the treatment device.

Conventionally, a blood vessel shape or a blood flow velocity, etc. of a subject before undergoing a treatment can be known from an image, etc. of the subject's body taken by a modality, such as an X-ray computed tomography (CT) apparatus, and such information has been utilized to design a treatment plan. However, it was difficult for a physician to estimate the flow after the actual placement of a treatment device from the information.

### BRIEF DESCRIPTION OF DRAWINGS

FIG. 1 is a block diagram showing an outline framework of a blood flow analysis apparatus (workstation) according to an embodiment.

FIG. 2 is a functional block diagram of the blood flow analysis apparatus according to the embodiment.

FIG. 3 is a flowchart showing an operation of the blood flow analysis apparatus according to the embodiment.

FIG. 4 is a schematic view of an example of a blood vessel model (an aorta model) in the embodiment.

FIG. 5 is a schematic view of an example of a device model (an artificial valve model) in the embodiment.

FIG. 6 is a schematic view of an example of an image in which the artificial valve model is arranged in the aorta model in the embodiment.

FIG. 7 shows an example of an image visualizing an analysis result in the embodiment.

FIG. 8 shows an example of an image visualizing an analysis result in the embodiment.

FIG. 9 shows an example of an image visualizing an analysis result in the embodiment.

FIG. 10 shows an example of an image visualizing an analysis result in the embodiment.

FIG. 11 shows an example of an image visualizing an analysis result in the embodiment.

FIG. 12 shows an example of an image visualizing an analysis result in the embodiment.

### DETAILED DESCRIPTION

In general, according to one embodiment, an medical fluid analysis apparatus includes processing circuitry.

The processing circuitry generates a treatment model. A device model is placed in a body cavity model in the treatment model. The device model represents a shape of a treatment device to be placed inside a body cavity of a subject. The body cavity model representing a shape of the body cavity of the subject.

The processing circuitry performs a fluid analysis on a fluid in the treatment model with a modification of the treatment model, based on characteristics at least including hardness of body cavity tissue in the body cavity model, characteristics at least including hardness of the treatment device in the device model, and fluid characteristics of the fluid inside the body cavity in the body cavity model.

The processing circuitry outputs an analysis result obtained by the processing circuitry.

Hereinafter, an embodiment will be described with reference to the drawings.

A medical fluid analysis apparatus according to the present embodiment comprises a treatment model generating unit, a fluid analysis unit, and an output unit. The treatment model unit generates a treatment model in which a device model is placed in a body cavity model by placing the device model, representing the shape of a treatment device to be placed inside a body cavity of a subject, in the body cavity model representing the shape of the body cavity of the subject. The fluid analysis unit performs a fluid analysis on a fluid in the treatment model along with making a modification of the treatment model based on characteristics including hardness of body cavity tissue in the body cavity model, characteristics including hardness of the treatment device in the device model, and fluid characteristics of a fluid inside the body cavity in the body cavity model. The output unit outputs an analysis result obtained by the fluid analysis unit.

Body cavity tissue is, for example, cerebral ventricles, a subarachnoid cavity, and tubular tissue. Tubular tissue is, for example, bronchial tubes, lymph vessels, and blood vessels. The body cavity model is a model of body cavity, such as a tubular model. A fluid in a body cavity is, for example, a cerebrospinal fluid, air, lymphatic fluid, or blood. The fluid inside the body cavity may be protons. For brevity, the body cavity in the explanation hereinafter is a blood vessel, the body cavity model is a blood vessel model, the body cavity tissue is blood vessel tissue, and the fluid is blood. For the sake of brevity, the medical flow analysis apparatus according to the present embodiment will be explained as a blood flow analysis apparatus. It should be noted that the body cavity model used in the fluid analysis by the medical fluid analysis apparatus is not limited to a tubular model (such as a blood vessel model). A fluid used for fluid analysis in the medical fluid analysis apparatus is not limited to blood.

The present medical fluid analysis apparatus may be integrated with a workstation of a picture archiving and communication system (PACS), for example. The medical fluid analysis apparatus may be connected to a workstation of a PACS, for example. The functions of the present medical fluid analysis apparatus may be provided on a cloud network. In this case, the medical fluid analysis apparatus is incorporated into the cloud network.

The present embodiment will disclose, as an example of a blood flow analysis apparatus, a workstation which performs flow analysis on a blood flow in and around the aortic valve of a subject when a treatment involved in TAVR is carried out on the subject.

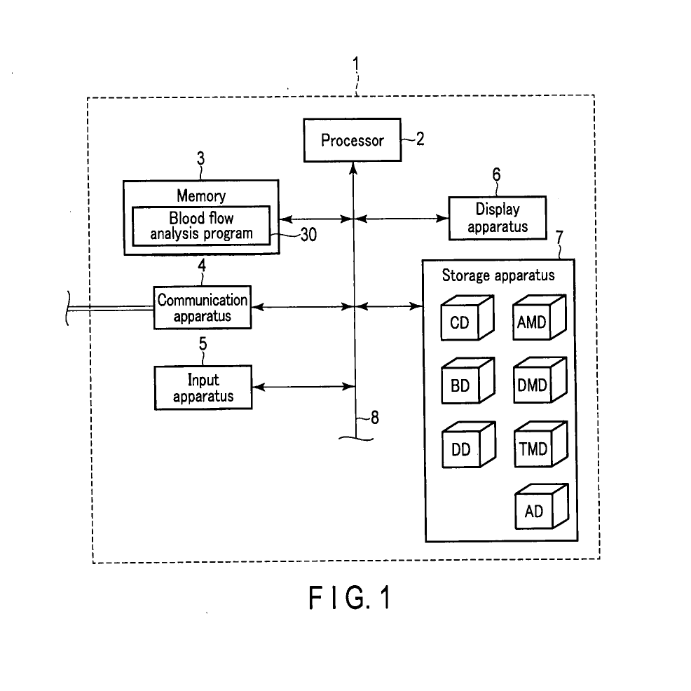

FIG. 1 is a function block diagram showing an example of a workstation 1 according to the present embodiment. The workstation 1 comprises a processor 2, a memory 3, a communication apparatus 4, an input apparatus 5, a display apparatus 6, a storage apparatus 7, and a bus line 8. The bus line 8 is composed of an address bus and a data bus, etc. that communicably connect the processor 2, the memory 3, the communication apparatus 4, the input apparatus 5, the display apparatus 6, and the storage apparatus 7.

The processor 2 is a central processing unit (CPU), for example, and realizes various processing by executing a computer program.

The memory 3 is a main memory including a read-only memory (ROM) and a random access memory (RAM). The memory 3 stores a blood flow analysis program 30, etc. to have the processor 2 realize major processing in the present embodiment. The memory 3 forms a working memory region for storing various information temporarily.

The communication apparatus 4 communicates with an external device by wire, or wirelessly. The external device is, for example, a modality such as an X-ray CT apparatus and an ultrasonic diagnostic apparatus, a server included in a system such as a PACS, etc., or other workstations, etc.

The input apparatus 5 is an interface for inputting commands, etc. in accordance with a user operation, such as a keyboard, a mouse, a touch panel, a track ball, and various buttons, etc.

The display unit 6 is a display, such as a liquid crystal display (LCD), and an organic electro luminescence display (OELD), etc.

The storage apparatus 7 is a hard disk drive (HDD) or a solid state drive (SSD), for example, which can store a relatively large amount of data. The storage apparatus 7 stores CT image data CD, B-mode image data BD, Doppler image data DD, aorta model data AMD, device model data DMD, treatment model data TMD, and analysis data AD, etc. The details of each data will be described later.

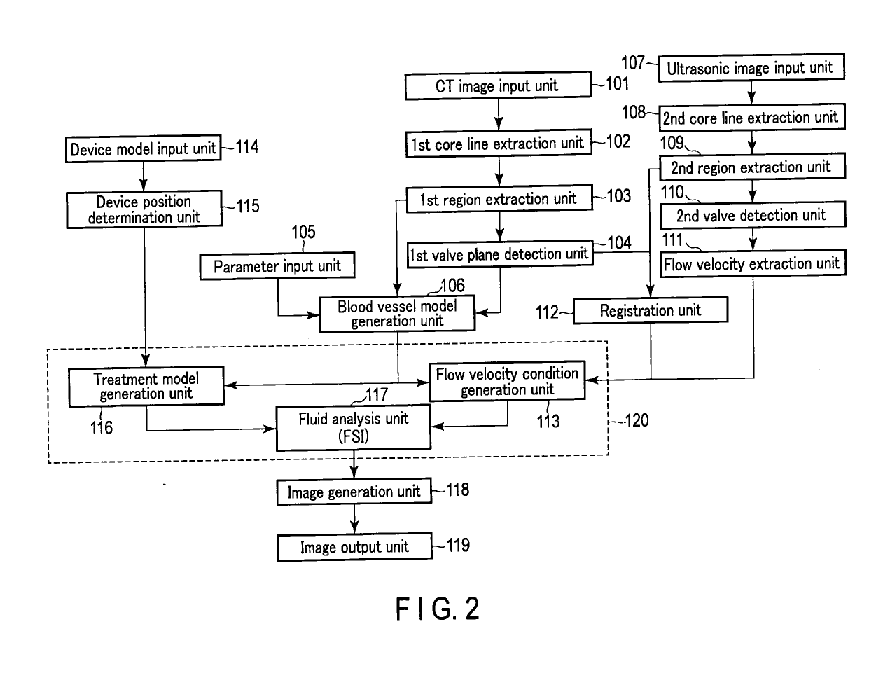

FIG. 2 is a block diagram showing the functions realized by executing a blood flow analysis program 30 by the processor 2. As illustrated in FIG. 2, the processor 2 realizes as the functions of a CT image input unit 101, a first core line extraction unit 102, a first region extraction unit 103, a first valve plane detection unit, a parameter input unit 105, a blood vessel model generation unit 106, an ultrasonic image input unit 107, a second core line extraction unit 108, a second region extraction unit 109, a second valve plane detection unit 110, a flow velocity extraction unit 111, a registration unit 112, a flow velocity condition generation unit 113, a device model input unit 114, a device position determination unit 115, a treatment model generation unit 116, a fluid analysis unit 117, an image generation unit 118, and an image input unit 119. In particular, the processing performed by the flow velocity generation unit 113, the treatment model generation unit 116, and the fluid analysis unit 117 constitute main processing 120 in the present embodiment.

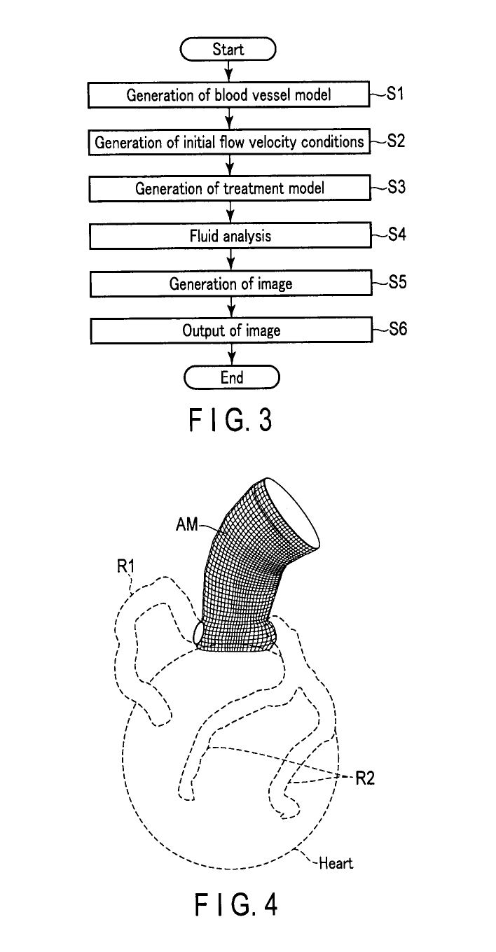

The processor 2 operates as each of the units to simulate and analyze blood flow around an artificial valve to be placed at the aortic valve of the subject by TAVR. The processing at the processor 2 is roughly illustrated in the flowchart of FIG. 3.

As shown in the flowchart, the processor 2 carries out the processes at step S1 through step S6. The process is started upon a user's input of a command to start operation using the input apparatus 5, for example.

The details of each step are explained as follows.

### [Step S1: Generation of Blood Vessel Model]

At step S1, the processor 2 functions as the CT image input unit 101, the first core line extraction unit 102, the first region extraction unit 103, the first valve plane detection unit, the parameter input unit 105, and the blood vessel model generation unit 106, to generate a blood vessel mode of the aorta region of the subject.

The CT image input unit 101 inputs, to the workstation 1, CT image data CD obtained from the aforementioned external device through a communication with the communication apparatus 4, for example, and the CT image data CD is stored in the storage apparatus 7. The CT image data CD is volume data obtained in advance by scanning the cardiac region of the subject with an X-ray CT apparatus. In the present embodiment in particular, the CT image data CD corresponds to a cardiac systole.

The first core line extraction unit 102 extracts an aorta core line included in the CT image data CD stored in the storage apparatus 7. For example, the first core line extraction unit 102 specifies an elongated region which is estimated to be an aortic lumen from the CT image data CD, based on a change in voxel values included in the CT image data CD and a predetermined characteristic amount generally related to the aorta. The first core line extraction unit 102 extracts a center line along with a longitudinal direction in the specified region as an aorta core line. The first core line extraction unit 102 may extract a line set by the user using the input apparatus 5 on the image displayed on the display apparatus 6 based on the CT image data CD, as a core line.

The first region extraction unit 103 extracts an aorta region from the CT image data CD based on the core line extracted by the first core line extraction unit 102. For example, to extract an aorta region, the first region extraction unit 103 specifies a boundary between the lumen and paries of the aorta and observes a change in voxel values in the CT image data CD in the radial direction with respect to the extracted core line along the overall length of the core line. The first region extraction unit 103 may extract a region set by a user using the input apparatus 5 on an image displayed on the display 6 based on the CT image data CD as an aorta region.

The first valve plane detection unit 104 detects a valve plane of the aortic valve included in the aorta region extracted by the first region extraction unit 103. The valve plane is defined as a central plane of a group of planes perpendicular to the aorta core line and including cusps of the aorta, for example. According to this definition, the first valve plane detection unit 104 scans a plane perpendicular to the core line in the aorta region extracted by the first region extraction unit 103 along the core line to extract a group of planes including cusps of the aorta, and sets a centered plane of the group of extracted planes as a valve plane. The first valve plane extraction unit 104 may extract a plane set by the user using the input apparatus 5 on the aorta region extracted by the first region extraction unit 103 displayed on the display 6, as a valve plane of the aorta.

The parameter input unit 105 inputs parameters related to the material conditions and blood flow conditions for the aorta in accordance with a user's operation of the input apparatus 5, for example. The parameter input unit 105 may input parameters from the above-mentioned external device to the workstation 1 by communicating with the external device through the communication apparatus 4. The material conditions are, for example, mechanical indexes related to a blood vessel wall. The mechanical indexes are, for example, indexes related to a displacement of a blood vessel wall, indexes related to a stress and distortion caused in a blood vessel wall, indexes related to an inner pressure distribution loaded on a blood vessel lumen, and indexes related to the material characteristics representing a hardness of a blood vessel, etc. The indexes related to the material characteristics representing hardness of a blood vessel are, for example, an average gradient of a curve representing the relationship between a stress and a strain of blood vessel tissue. The blood flow conditions are, for example, indexes related to a viscosity of blood. Other than the above-mentioned indexes, the parameter input unit 105 may input various parameters necessary for simulating blood flow in the aorta.

The parameter input unit 105 inputs, for example, characteristics including the hardness of the body cavity tissue in the body cavity model, and characteristics including the hardness of the blood vessel in the blood vessel model, as the material conditions. The characteristics may include characteristics related to the shape of the body cavity tissue, e.g., characteristic of the shape of the blood vessel tissue.

The blood vessel model generation unit 106 generates an aorta model, which is a variation of the blood vessel model, based on the region extracted by the first region extraction unit 103 and the location of the valve plane detected by the first valve plane detection unit 104, etc.

FIG. 4 is a schematic view of an example of the aorta model AM generated by the blood vessel model generation unit 106. FIG. 4 indicates the locations of each of the heart, the right coronary artery R1, and the left coronary artery R2 by broken lines, in addition to the aorta model AM indicating the tube inner wall by a set of a number of polygons.

The blood vessel model generation unit 106 has the storage unit 7 store aorta model data AMD indicating the generated aorta model with the parameters related to the material conditions, and blood flow conditions inputted by the parameter input unit 105.

### [Step S2: Generation of Initial Flow Velocity Condition]

In step S2, the processor 2 functions as the ultrasonic image input unit 107, the second core line extraction unit 108, the second region extraction unit 109, the second valve plane detection unit 110, the flow velocity extraction unit 111, the registration unit 112, and the flow velocity condition generation unit 113, to generate initial flow velocity conditions of the aorta model generated at step S1.

The ultrasonic image input unit 107 inputs, to the workstation 1, the B-mode image data BD and the Doppler image data DD obtained from the aforementioned external device through communication with the communication apparatus 4, for example, and the data is stored in the storage apparatus 7. The B-mode image data BD is three-dimensional data expressing an aspect of the cardiac region of the subject in the form of luminance, and the B-mode image data BD is obtained by scanning in advance in a Doppler mode the cardiac region with an ultrasonic diagnostic apparatus. For example, the Doppler image data DD is three-dimensional data indicating a blood flow vector distribution related to an average velocity of a blood flow which is obtained by scanning in advance in a Doppler mode the cardiac region of the subject with an ultrasonic diagnostic apparatus. In the present embodiment in particular, the B-mode image data BD and the Doppler image data DD are obtained by scanning the same region, without moving an ultrasonic probe, and correspond to a cardiac systole, like the CT image data CD.

The second core line extraction unit 108 extracts the aorta core line included in the B-mode image data BD that the ultrasonic image input unit 107 has the storage apparatus 7 store. As a method of core line extraction by the second core line extraction unit 108, a method similar to the one adopted in the first core line extraction unit 102 can be adopted.

The second region extraction unit 109 may extract an aorta region from the B-mode image data BD based on the core line extracted by the second core line extraction unit 108. As a method of aorta region extraction by the second region extraction unit 109, a method similar to the one adopted in the first region extraction unit 103 can be adopted.

The second valve plane detection unit 110 detects a valve plane of the aortic valve included in the B-mode image data BD inputted by the ultrasonic image input unit 107. As a method of detecting a valve plane by the second valve plane detection unit 110, a method similar to the one adopted in the first valve plane detection unit 104 can be adopted.

The flow velocity extraction unit 111 extracts a blood flow vector distribution in the aorta region extracted by the second region extraction unit 109.

The registration unit 112 positions the aorta region in the CT image data CD extracted by the first region extraction unit 103 and the aorta region in the B-mode image data BD extracted by the second region extraction unit 109. Specifically, the registration unit 112 specifies a relative position relationship (scale, rotation angle, etc.) of the aorta region in the B-mode image data BD with respect to the aorta region in the CT image data CD, based on the characteristic parts, such as the valve plane locations detected by the first valve plane detection unit 104 and the second valve plane detection unit 110, the aortic root in both of the aorta regions, and the part connecting the aorta and the left and right coronary artery.

The flow velocity condition generation unit 113 generates initial flow velocity conditions based on medical image data (the B-mode image data and the Doppler image data) including blood flow information. Specifically, the flow velocity condition generation unit 113 generates initial flow velocity conditions related to an initial flow velocity in the aorta model generated by the blood vessel model generation unit 106, based on the blood flow vector extracted by the flow velocity and the position relationship specified by the registration unit 112. Specifically, the flow velocity condition generation unit 113 performs conversion to compound, expand, or rotate the blood flow vector distribution extracted by the flow velocity extraction unit 111, based on the position relationship specified by the registration unit 112. The blood flow vectors after the conversion process become initial flow velocity conditions. The flow velocity generation unit 113 has the storage unit 7 store the generated initial flow velocity conditions. The initial flow velocity conditions correspond to, for example, fluid characteristics related to a fluid in the body cavity tissue in the body cavity model. The fluid characteristics may include blood flow conditions (indexes related to the viscosity of the blood, etc.) explained in step S1. The fluid characteristics may include indexes related to cerebrospinal fluid, lymphatic fluid, air, etc. as fluids in the body cavity tissue.

### [Step S3: Generation of Treatment Model]

In step S3, the processor 2 functions as the device model input unit 114, the device position determination unit 115, and the treatment model generation unit 116, to generate a treatment model in which the artificial valve model is placed in the aorta model.

The device model input unit 114 inputs, to the workstation 1, device model data DMD and material conditions obtained from the aforementioned external device through communication with the communication apparatus 4, for example, and the device model data DMD and material conditions are stored in the storage apparatus 7. The device model data DMD in the present embodiment is an artificial valve model representing the form of the artificial valve placed inside the body of the subject. The artificial valve model is, for example, three-dimensional CAD data generated when the artificial valve, etc. is designed. The material conditions in this case are related to the artificial valve model.

The device model input unit 114 inputs characteristics including a hardness of the treatment device in the device model, for example, as the above material conditions. These characteristics may have characteristics related to the shape of the treatment device.

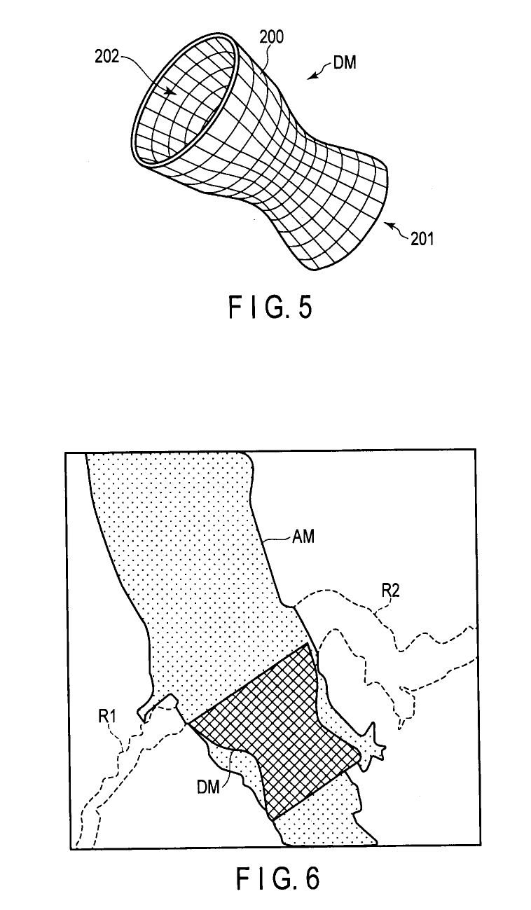

FIG. 5 is a schematic view of an example of the artificial valve model DM indicated by the device model data DMD. The artificial valve model DM includes a cylindrical-shaped stent 200. A plurality of valve members (not shown in the drawings) made of flexible material are provided inside of the stent 200. Each of the valve materials opens when the pressure on the entrance 201 side is higher than that on the exit 202 side, and closes when the pressure on the entrance 201 side is lower than that on the exit 202 side. Each of the valve members are movable. In the present embodiment, the device model data DMD indicating the shape corresponding to the systole, that is, indicating the artificial valve model DM in the state where each of the valve members opens, is inputted by the device model input unit 114.

The material conditions related to the artificial valve model are mechanical indexes related to each part in the artificial valve model DM, for example. The mechanical indexes are, for example, indexes related to fluctuations in each part in the artificial valve model DM, indexes related to stress and distortion caused in each part in the artificial valve model DM, and indexes related to the material characteristics representing a hardness of each part in the artificial valve model DM. The indexes related to the material characteristics are, for example, an average gradient of a curve representing the relationship between a pressure and a distortion of each part of the artificial valve model DM.

The device position determination unit 115 determines a position at which the artificial valve is placed in the blood vessel model generated by the blood vessel model generation unit 106. For example, the device position determination unit 115 has the display apparatus 6 display an image in which the artificial valve model indicated by the device model data DMD stored in the storage apparatus 7 is placed at the valve plane location in the aorta model indicated by the aorta model data AMD stored in the storage apparatus 7.

FIG. 6 is a schematic view of an example of the image in which the artificial valve model DM is placed at the valve plane location of the aorta model AM. In this example, the image in which the artificial valve model DM is placed on the cross section along the core line of the aorta model AM is shown; however, the form of display is not limited thereto.

The user can adjust the position or angle of the artificial valve model DM in the image by operating the input apparatus 5. The device position determination unit 115 determines the position of the artificial valve after the adjustment as a final placement position.

The treatment mode generation unit 116 generates a treatment model in which the artificial valve model indicated by the device model data DM stored in the storage unit 7, is placed in the aorta model, indicated by the aorta model data AMD stored in the storage apparatus 7 at the position determined by the device position determination unit 115. The blood vessel model generation unit 116 has the storage unit 7 store the treatment model data TMD indicating the generated treatment model along with the material conditions and blood flow conditions of the aorta model stored in the storage unit 7, the aorta model data AMD, and the material conditions that are stored in the storage apparatus 7 along with the device model data DMD.

### [Step S4: Fluid Analysis]

In step S4, the processor 2 functions as the fluid analysis unit 117.

The fluid analysis unit 117 performs a fluid analysis based on the treatment model data TMD, the material conditions and blood flow conditions of the aorta model, the material conditions of the artificial valve model, and the initial flow velocity conditions. These data are stored in the storage apparatus 7.

For example, the fluid analysis unit 117 uses computation fluid dynamics (CFD) in accordance with an algorithm such as a finite element method (FEM) and a finite volume method (FVM), for a fluid (blood) in the vicinity of the treatment model and the device model indicated by the treatment model data TMD) as a target for analysis. The device model may be included as an analysis target.

When a variation of the treatment model based on a fluid (blood) is considered, the fluid analysis unit 117, for example, performs fluid-structure interaction (FSI) analysis in consideration of the material conditions (hardness, shape) of the aorta model and the artificial valve model, etc., using an initial condition. The initial condition is a model which includes blood flow vectors corresponding to the initial flow velocity conditions. The blood flow vectors are respectively assigned to a large number of cells set in the treatment model. In other words, the fluid analysis unit 117 calculates a behavior simulation of blood in the treatment model and the treatment model (and the device model) itself by performing FSI analysis in the CFD using FEM or FVM. When the treatment model is in a constant status during the FSI analysis, the fluid analysis unit 117 generates analysis data AD indicating a blood flow vector distribution of the blood flow velocity in the treatment mode. A variety of known CFD methods can be adopted. The fluid analysis unit 117 has the storage apparatus 7 store the generated analysis data AD.

Specifically, the fluid analysis unit 117 sets a blood flow vector in the initial flow velocity conditions and a device model for the treatment model in the simulation space formed by a FEM or a FVM. At this time, the fluid analysis unit 117 gives the material conditions (characteristics including hardness and shape) to the treatment model in the simulation space. The fluid analysis unit 117 also gives the material conditions (characteristics including hardness and shape) to the device model in the simulation space. In addition, the fluid analysis unit 117 gives fluid characteristics to the blood flow vector.

The fluid analysis unit 117 performs FSI analysis using the above setting as an initial condition. At this time, the shape of the treatment model is changed by a blood pressure which is commensurate with a blood flow vector. The blood flow vector fluctuates in accordance with the change of the shape of the treatment model. Furthermore, the shape of the treatment model is changed in accordance with the fluctuation of the blood flow vector. Thus, the fluid analysis unit 117 performs FSI analysis to simulate mutual influence between the blood flow vector and the treatment model. The fluid analysis unit 117 generates a blood flow vector distribution corresponding to the constant status as analysis data AD if the behavior of the blood flow vector and the behavior of the treatment model are within a predetermined range of behaviors and in a constant status. The analysis data AD may include data of the shape of the treatment model in a constant status (and data of the device model). The fluid analysis unit 117 may generate a fluctuation of the blood vector distribution over a predetermined cycle as analysis data AD, if the behavior of the blood vector and the behavior of the treatment model are in a constant status at a predetermined cycle (e.g., one pulse, one breath).

As described in the above, each of the CT image data CD and the device model data DMD which is the origin of generation for the treatment model, and the B-mode image data BD and the Doppler image data DD which are the origin of generation for the initial flow velocity conditions, corresponds to a cardiac systole. Thus, the analysis data AD indicates a blood vector distribution corresponding to a cardiac phase in which a blood flow in the aorta in one cardiac cycle is the fastest.

### [Step S5: Generation of Image]

In step S5, the processor 2 functions as the image generation unit 118.

The image generation unit 118 generates image data of a visualized image of the analysis result obtained at the fluid analysis unit 117.

For example, the image generation unit 118 generates image data of a visualized blood vector distribution indicated by analysis data AD in the treatment model indicated by the treatment model data TMD. The image generation unit 118 may generate image data of a visualized blood vector distribution indicated by the analysis data AD in an image generated based on the CT image data CD. The blood flow vector distribution may be visualized by placing an arrow indicating the blood flow vector in an image, or by coloring an image in accordance with the size of the blood flow vector component corresponding to a specific direction.

On the assumption that the function of the artificial valve itself is always normal, it can be assumed that the blood flow in the artificial valve is always normal.

Accordingly, the image generation unit 118 may distinctively visualize a blood flow vector between the artificial valve model and a paries of the aorta model.

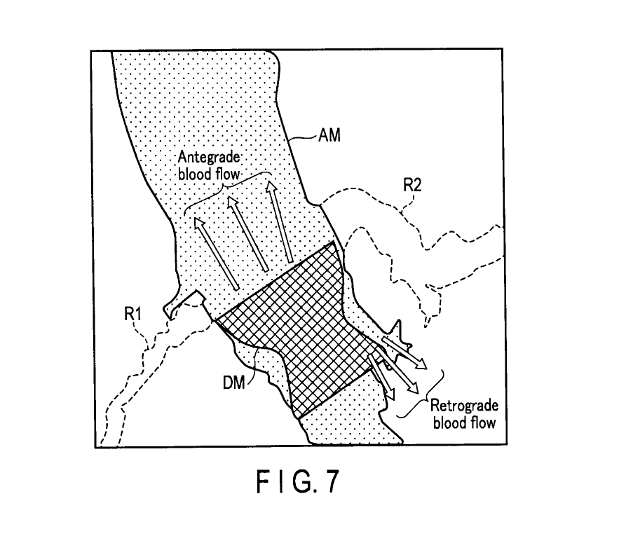

FIG. 7 to FIG. 12 illustrate an aspect of the image generated by the image generation unit 118.

FIG. 7 shows an image of a partially-visualized blood vector distribution indicated by the analysis data AD in the cross section along the core line of the treatment model indicated by the treatment model data TMD. In this example, the antegrade blood flow flowing in a reference direction, which is a normal blood flow direction, and the retrograde blood flow in a direction opposite to the reference direction, are indicated by the arrows. The reference direction is a direction going away from the left ventricle along the core line, for example. The antegrade blood flow is a blood flow having a positive velocity component with respect to the reference direction, for example. The retrograde blood flow is a blood flow having a negative velocity component with respect to the reference direction, for example. In the present example, three arrows respectively corresponding to representative values of the antegrade blood flow in the vicinity of the exit of the artificial valve model DM are shown. Each of the representative values is, for example, an average of a blood flow vector in the vicinity of the exit in the artificial valve model DM for each predetermined region. In addition, in the present example, three arrows respectively corresponding to representative values of the retrograde blood flow are shown at the locations where the retrograde blood flow occurs. The representative values are, for example, an average vector value of blood flow vectors in the regions where a retrograde blood flow occurs, taken at each predetermined region.

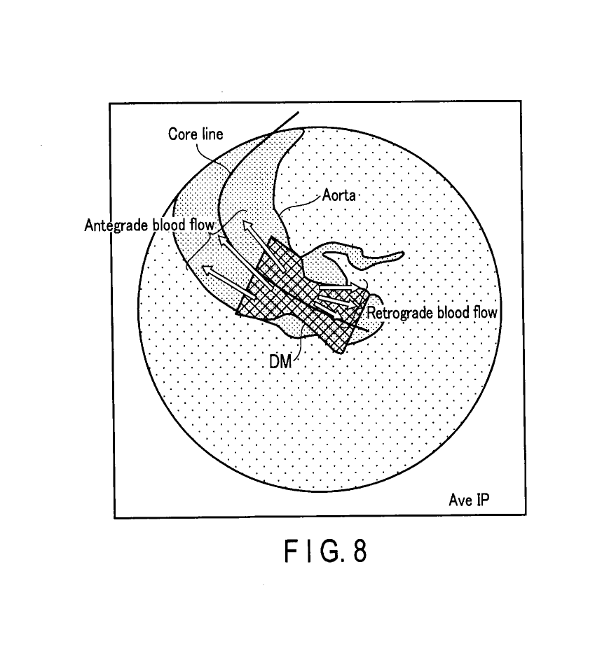

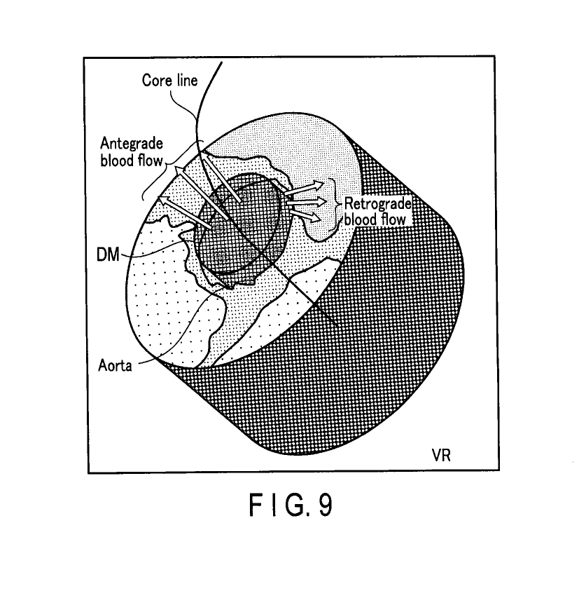

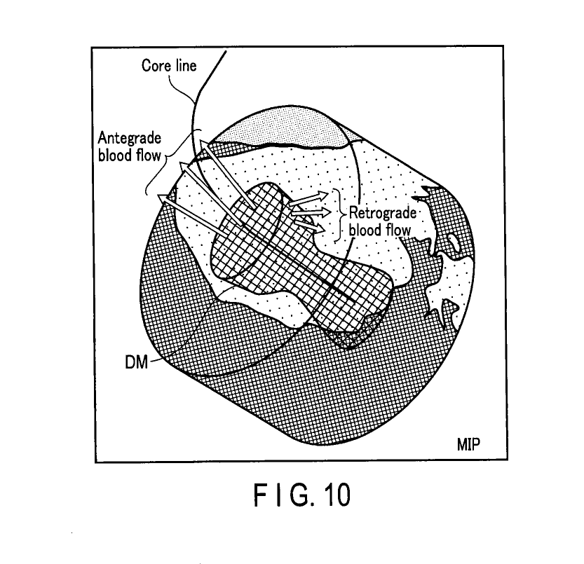

FIG. 8 to FIG. 10 show an image of a partially-visualized blood flow vector distribution indicated by the analysis data AD in the image generated based on the CT image data CD. FIG. 8 is an example where an average intensity projection (AveIP) image generated based on the CT image data CD is used. FIG. 9 is an example where a volume rendering (VR) image generated based on the CT image data CD is used. FIG. 10 is an example where a maximum intensity projection (MIP) image generated based on the CT image data CD is used. In FIG. 8 to FIG. 10, in addition to the image generated based on the CT image data CD, the core lines extracted by the first core line extraction unit 102 and the artificial valve model DM are shown. The displayed aspect of the antegrade blood flow and the retrograde blood flow is the same as the example illustrated in FIG. 7.

In the examples shown in FIG. 7 to FIG. 10, each of the antegrade blood flow and the retrograde blood flow is shown by three arrows; however, more arrows can be adopted. For example, all vectors included in the blood flow vector distribution indicated by the analysis data AD may be shown by arrows.

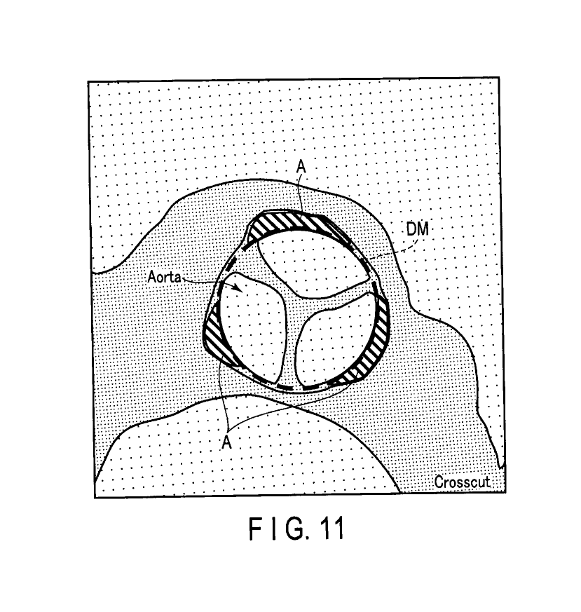

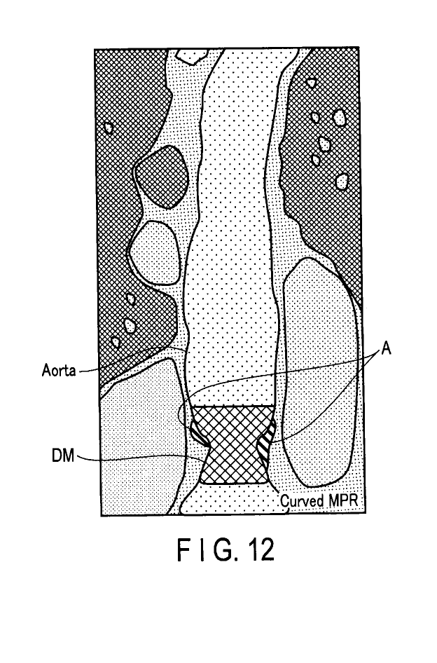

FIG. 11 and FIG. 12 show an image of a visualized blood flow vector in a gap A formed between the artificial valve model DM and the paries of the aorta in an image generated based on the CT image data CD. FIG. 11 shows an example where a tomogram in the valve plane detected by the first valve plane detection unit 104 (a cross-cut image with respect to the core line) is used. FIG. 12 shows an example where a curved multi planar reconstruction (MPR) image taken along the core line is used. In those images, the blood flow vector in the gap A is colored in accordance with the speed of the velocity component with respect to, for example, the reference direction. In FIGS. 11 and 12, the gap A is entirely diagonally shaded, instead of coloring.

FIG. 7 to FIG. 12 illustrate a case where a blood flow velocity indicated by the blood flow vector distribution is visualized. However, the image generation unit 118 may visualize other indexes indicating a blood flow.

For example, the image generation unit 118 may calculate an amount of blood flow based on the blood flow vector distribution to generate image data of an image visualizing the amount of blood flow.

The image generation unit 118 may generate image data of an image visualizing an amount of deviation between the blood flow vector in the blood flow vector distribution and the reference direction. Such amount of deviation may be set as an angle which the blood flow vector forms with the reference direction, for example.

The image generation unit 118 may calculate an area of the region corresponding to a part where a retrograde blood flow occurs included in a specific cross section, and a volume of a region corresponding to a part where a retrograde blood flow occurs included in a specific three-dimensional region.

### [Step S6: Output of Image]

In step S6, the processor 2 functions as the image output unit 119.

The image output unit 119 outputs the image data generated by the image generation unit 118. For example, the image output unit 119 has the display apparatus 6 display an image based on the image data. The image output unit 119 may send the image data to an external device through the communication apparatus 4.

The series of processes by the processor 2 is finished after step S6.

As explained above, the workstation 1 according to the present embodiment generates a treatment model in which an artificial valve model is placed in an aorta model, performs a fluid analysis on the treatment model, and outputs the analysis result. By referring to the analysis result, physicians and the like can know a blood flow status when an artificial valve is placed in an aorta of a subject in advance of performing TAVR. Thus, it is possible to know a location, a range, and a shape, etc. of an anatomical local part with a high risk of blood flow leakage from an artificial valve (an retrograde blood flow) at a stage of planning a TAVR treatment plan, thereby discussing countermeasures against a leak before carrying out a treatment.

By combining a real-time X-ray fluoroscopic image taken by an X-ray fluoroscopic imaging apparatus during the operation of TAVR with an image based on the analysis data AD, it is possible to provide an operator with a real-time image of areas with a high risk of developing leaks.

Various preferable effects other than the above described can be achieved from the structures disclosed in the present embodiment.

### Examples of Variations

Some variation examples will be described below.

In the above-described embodiment, the workstation 1 was disclosed as an example of a blood flow analysis apparatus. However, it is possible to have a console of an X-ray CT apparatus, an ultrasonic diagnostic apparatus, or an X-ray fluoroscopic photographing apparatus, or a server included in a system, such as a PACS, etc. execute the process from step S1 through step S6, and to have those apparatuses function as a blood flow analysis apparatus.

In the above embodiment, the case where a blood flow analysis is performed for a cardiac systole was illustrated. By targeting a cardiac systole, it is possible to obtain an analysis result for a cardiac phase where a blood flow of the aorta becomes the fastest. However, the target cardiac phase for analysis is not limited to a cardiac systole, and other cardiac phases may be targets as well. It is also possible to perform the process from step S1 through step S6 for one cardiac cycle as a target.

In the above embodiment, the case where the blood vessel model is generated based on CT image data CD generated by the X-ray CT apparatus was illustrated. However, a blood vessel model may be generated based on other medical image data, such as image data generated by a magnetic resonance imaging (MRI) apparatus or B-mode image data generated by an ultrasonic diagnostic apparatus.

The blood flow analysis apparatus may comprise a function of performing a blood flow analysis in consideration of age deterioration of an artificial valve. For example, by knowing in advance, through conducting experiments, etc., changes over time due to age degradation in the shape or the material conditions of the artificial valve placed in a subject by, a plurality of artificial valves and multiple sets of material conditions can be prepared in consideration of age degradation in every predetermined period of elapsed time. The blood flow analysis apparatus performs a blood flow analysis in consideration of age degradation in every predetermined period of elapsed time by carrying out the process from step S1 through step S6 using these artificial valve models and material conditions. If a result of such blood flow analysis is used, it is possible to evaluate a long-term risk related to a leak after performing TAVR. Furthermore, the blood flow analysis apparatus may convert the leak-related risk into numbers based on a blood flow analysis result for every period of elapsed time, and output the converted risk in numerical values. Such numerical conversion may be carried out for an area of a region where a retrograde blood flow occurs included in a specific cross section, or for a volume of a region where a retrograde blood flow occurs included in a specific three-dimensional region.

A blood flow analysis program 30 is not necessarily written in a memory of a blood flow analysis apparatus at the time of manufacturing the apparatus. The blood flow analysis program 30 written in a storage medium, such as a CD-ROM and a flash memory, etc., may be provided to a user, and may be installed from the storage medium onto a computer of a blood flow analysis apparatus, etc. A blood flow analysis program 30 downloaded through a network may be installed onto a computer of a blood flow analysis, etc.

It is also possible to perform a blood flow analysis related to a treatment other than TAVR during the process from step S1 through step S6. Other types of treatment may be a stent indwelling technique and a coil embolization technique, etc. If a stent indwelling technique is adopted, the blood flow analysis apparatus generates a blood vessel model for a blood vessel which is a target for placing a stent or a stent graft at step S1, in a coronary artery for example, and generates initial flow velocity conditions of the blood vessel at step S2, generates a treatment model at step S3 in which a device model representing a shape of the stent or the stent graft is placed in the blood vessel model, and performs an analysis, generates an image, and outputs an image for the treatment model at steps S4 through S6. If a coil embolization technique is adopted, the blood flow analysis apparatus generates, at step S1, a blood vessel model for an aneurysm region which is a target for embolization, for example, a cerebral aneurysm, and generates initial flow velocity conditions in the vicinity of the cerebral aneurysm at step S2, generates, at step S3, a treatment model in which a device model representing a shape.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A medical fluid analysis apparatus comprising:
processing circuitry configured to generate a treatment model in which a device model is placed in a body cavity model, the device model representing a shape of a treatment device to be placed inside a body cavity of a subject, the body cavity model representing a shape of the body cavity of the subject;
to perform a fluid analysis on a fluid in the treatment model with a modification of the treatment model, based on characteristics at least including hardness of body cavity tissue in the body cavity model, characteristics at least including hardness of the treatment device in the device model, and fluid characteristics of the fluid inside the body cavity in the body cavity model; and
to output an analysis result obtained by the processing circuitry.

2. The medical fluid analysis apparatus according to claim 1, wherein the body cavity has a tubular shape, the body cavity tissue is tubular tissue, and the body cavity model is a tubular model.

3. The medical fluid analysis apparatus according to claim 2, wherein the tubular shape is a blood vessel, the tubular tissue is blood vessel tissue, and the tubular model is a blood vessel model.

4. The medical fluid analysis apparatus according to claim 3, wherein the characteristics at least including the hardness of the blood vessel tissue has characteristics related to the shape of the blood vessel tissue,
the characteristics at least including the hardness of the treatment device has characteristics related to the shape of the treatment device.

5. The medical fluid analysis apparatus according to claim 3, wherein the processing circuitry is configured to make display an image of the analysis result visualized on the treatment model.

6. The medical fluid analysis apparatus according to claim 3, wherein the processing circuitry is configured to calculate a vector distribution of a blood flow in the treatment model in the fluid analysis, and
to output an image of a visualized vector including a component in a direction opposite to a reference direction in the vector distribution.

7. The medical fluid analysis apparatus according to claim 3, wherein the processing circuitry is configured to calculate a vector distribution of a blood flow in the treatment model in the fluid analysis, and
to output a visualized image of the vector distribution between the device model in the treatment model and paries of the blood vessel model.

8. The medical fluid analysis apparatus according to claim 3, wherein processing circuitry is configured to generate the blood vessel model based on three-dimensional medical image data including the blood vessel of the subject.

9. The medical fluid analysis apparatus according to claim 8, wherein the medical image data is image data generated by an X-ray CT apparatus.

10. The medical fluid analysis apparatus according to claim 3, wherein the fluid characteristics includes initial flow velocity conditions related to an initial flow velocity in the blood vessel in the blood vessel model, and
the processing circuitry is configured to generate the initial flow velocity conditions based on medical image data including blood flow information in the blood vessel of the subject.

11. The medical fluid analysis apparatus according to claim 10, wherein the medical image data including the blood flow information in the blood vessel of the subject is B-mode image data and Doppler image data generated by an ultrasonic diagnostic apparatus.

12. The medical fluid analysis apparatus according to claim 3, wherein the treatment device is an artificial valve, a stent, a stent graft, or a coil.

13. A medical fluid analysis method, comprising:
generating a treatment model in which a device model is placed in a body cavity model, the device model representing a shape of a treatment device to be placed inside a body cavity of a subject, the body cavity model representing a shape of the body cavity of the subject;
performing a fluid analysis on a fluid in the treatment model with a modification of the treatment model, based on characteristics at least including hardness of body cavity tissue in the body cavity model, characteristics at least including hardness of the treatment device in the device model, and fluid characteristics of the fluid inside the body cavity in the body cavity model; and
outputting an analysis result of the fluid analysis.
